(19) United States
(12) Patent Application Publication
(10) Pub. No.: US 2008/0050978 A1
(43) Pub. Date: Feb. 28, 2008

(54) ELECTRICAL CONNECTOR WITH MULTIPLE OUTPUTS AND POWER ADAPTER HAVING THE SAME

(75) Inventors: Ming-Tsung Lee, Taoyuan Hsien (TW); Jui-Yuan Hsu, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 11/555,551

(22) Filed: Nov. 1, 2006

(30) Foreign Application Priority Data
Aug. 28, 2006 (TW) 095131639

(51) Int. Cl. H01R 24/04

(52) U.S. Cl. 439/668

(57) ABSTRACT

An electronic connector includes a housing and a plurality of electricity-conducting elements. The housing has a channel therein. The electricity-conducting elements are separated from each other. Each electricity-conducting element includes a first conducting part and a second conducting part. The first conducting part is partially received within the housing and partially exposed to the channel. The second conducting part is extended from the housing. One of the electricity-conducting elements is selected to transmit an output voltage through the first conducting part and the second conducting part of the selected electricity-conducting element.

### FIELD OF THE INVENTION

The present invention relates to an electrical connector, and more particularly to an electrical connector with multiple outputs. The present invention also relates to a power adapter having such an electrical connector.

### BACKGROUND OF THE INVENTION

Power adapters are essential for many electronic appliances such as notebook computers or mobile phones. Usually, the user may simply insert a plug of a power adapter into an AC wall outlet commonly found in most homes or offices so as to receive an AC voltage. The power adapter will convert the AC voltage into a regulated DC output voltage for powering the electronic device and/or charging a battery built-in the electronic appliance. Referring to FIG. 1, a schematic view of a conventional power adapter having multiple outputs is illustrated. The power adapter 1 includes a main body 10, a power input device 11 and a power output device 12. The power input device 11 is connected to the input terminal of the main body 10 for receiving an AC voltage from an external power source. The power output device 12 is connected to the output terminal (i.e. an electronic connector 101) of the main body 10. The AC voltage transmitted from the external power source is converted by the power converting circuitry of a printed circuit board inside the main body 10 into a regulated DC output voltage. The power input device 11 includes a first plug 111, a cable 112 and a second plug 113. The power output device 12 includes a first plug 121, a cable 122 and a second plug 123.

The input terminal and the output terminal of the main body 10 are electrically connected to the first plug 111 of the power input device 11 and the first plug 121 of the power output device 12, respectively. The second plug 113 of the power input device 11 is plugged into an AC wall outlet for receiving an AC voltage. The second plug 123 of the power output device 12 is plugged into a power socket 21 of an electronic appliance 2 such as a notebook computer. The AC voltage is transmitted from the external power source to the power adapter 10 through the second plug 113, the cable 112 and the first plug 111 of the power input device 11, and then converted by the power converting circuitry of a printed circuit board inside the power adapter 10 into a regulated DC output voltage. The regulated DC output voltage (e.g. 12V) is then supplied to the electronic appliance 2 through the first plug 121, the cable 122 and the second plug 123 of the power output device 12, thereby powering the electronic appliance 2 and/or charging a battery built-in the electronic appliance 2.

As known, the first plug 121 to be coupled with the electronic connector 101 of the power adapter 1 should comply with a particular specification, and the regulated DC output voltage to be supplied to the electronic appliance 2 is specified, e.g. 12V. In other words, this power adapter 1 fails to provide different regulated DC output voltages, e.g. 5V or 3.3V. For providing different regulated DC output voltages, at least two power adapters should be purchased. Simultaneous use of at least two power adapters is costly and wastes resources.

In views of the above-described disadvantages, the applicant keeps on carving unflaggingly to develop an electrical connector with multiple outputs and a power adapter having such an electrical connector according to the present invention through wholehearted experience and research.

### SUMMARY OF THE INVENTION

It is an object of the present invention to provide an electronic connector with multiple outputs and a power adapter having such an electronic connector for transmitting different regulated DC output voltages to power different electronic apparatuses.

It is another object of the present invention to provide an electronic connector with multiple outputs and a power adapter having such an electronic connector so as to increase application thereof and reduce fabricating costs.

In accordance with an aspect of the present invention, there is provided an electronic connector having multiple outputs. The electronic connector includes a housing and a plurality of electricity-conducting elements. The housing has a channel therein. The electricity-conducting elements are separated from each other. Each electricity-conducting element includes a first conducting part and a second conducting part. The first conducting part is partially received within the housing and partially exposed to the channel. The second conducting part is extended from the housing. One of the electricity-conducting elements is selected to transmit an output voltage through the first conducting part and the second conducting part of the selected electricity-conducting element.

In accordance with another aspect of the present invention, there is provided a power adapter including a power input device, a main body and a plurality of power output devices. The main body includes a circuit board and an electronic connector. The circuit board is electrically interconnected between the power input device and the electronic connector. The electronic connector includes a plurality of electricity-conducting elements. Each electricity-conducting element includes a first conducting part and a second conducting part. The first conducting parts of the electricity-conducting elements are arranged at different positions of the electronic connector. The power output devices include respective first output plugs, which have respective first conducting portions corresponding to respective first conducting parts of the electricity-conducting elements. The first output plugs of the power output devices are selectively plugged into the electronic connector to output different regulated output voltages.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view of a conventional power adapter having multiple outputs;

FIG. 2 is a schematic view of a power adapter according to a preferred embodiment of the present invention;

FIGS. 3(a) and 3(b) are schematic front and rear exploded views of the electronic connector used in FIG. 2, respectively;

FIG. 4 is a schematic assembled view of the electronic connector shown in FIG. 2 to be mounted on a circuit board;

FIG. 5 is a partial perspective view illustrating the connection between the first output plugs of the power output devices and the electronic connector shown in FIG. 2;

FIG. 6 is a schematic view of a power adapter according to another preferred embodiment of the present invention;

FIGS. 7(a) and 7(b) are schematic front and rear exploded views of the electronic connector used in FIG. 6, respectively;

FIG. 8 is a schematic assembled view of the electronic connector shown in FIG. 6 to be mounted on a circuit board; and

FIG. 9 is a partial perspective view illustrating the connection between the first output plugs of the power output devices and the electronic connector shown in FIG. 6.

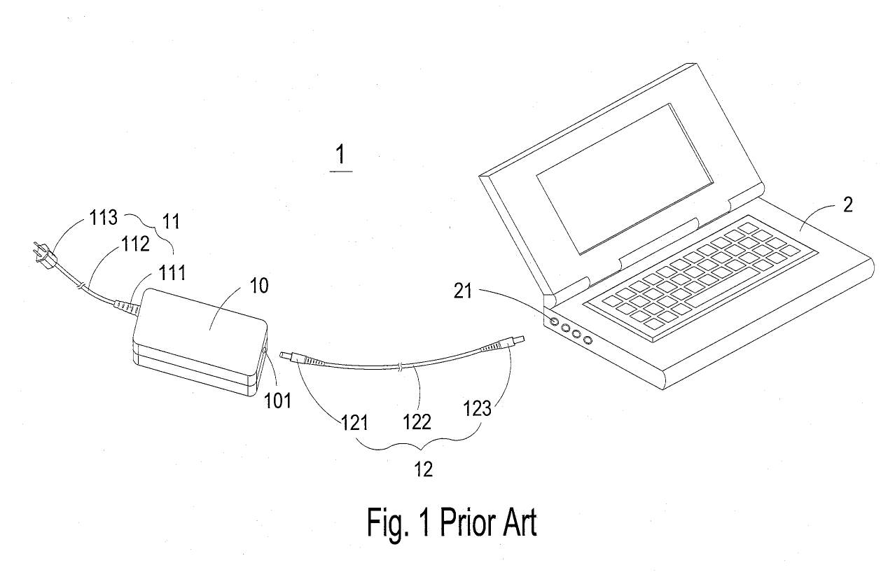

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

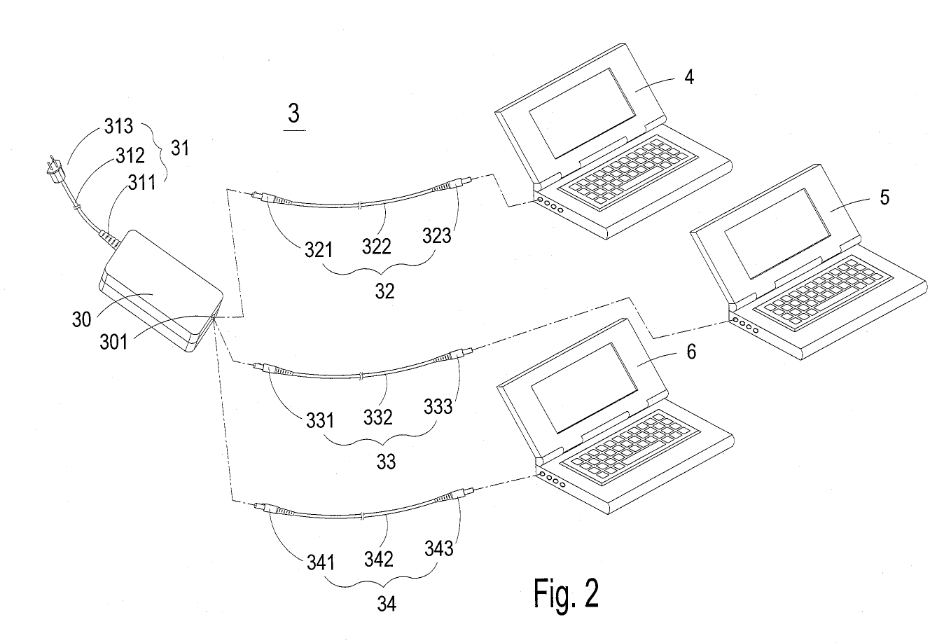

Referring to FIG. 2, a schematic view of a power adapter according to a preferred embodiment of the present invention is illustrated. The AC voltage transmitted from the external power source is converted by the power converting circuitry of a printed circuit board inside the power adapter 3 into different regulated DC output voltages, e.g. 12V, 5V and/or 3.3V, for powering different electronic apparatuses. For example, the voltages 12V, 5V and 3.3V are differentially selected for powering a first electronic appliance 4, a second electronic appliance 5 and a third electronic appliance 6. The power adapter 3 includes a main body 30, at least one power input device 31 and multiple power output devices 32, 33 and 34. The main body 30 includes a power input terminal, a power output terminal (i.e. an electronic connector 301) and a circuit board (not shown). The circuit board has a power converting circuit mounted thereon for converting the AC voltage into different regulated DC output voltages. The operation principles of the power converting circuit are known in the art, and are not redundantly described herein. Moreover, the power input device 31 includes a first input plug 311, a cable 312 and a second input plug 313. The power output devices 32, 33 and 34 have respective first output plugs 321, 331, 341, respective cables 322, 332, 342 and respective second output plugs 323, 333, 343.

The second plug 313 of the power input device 31 is plugged into an AC wall outlet for receiving an AC voltage. The first input plug 311 of the power input device 31 is connected to the input terminal of the main body 30. The output terminal (i.e. the electronic connector 301) of the main body 30 is selectively and detachably connected to the output plug 321 of the first power output device 32, the output plug 331 of the second power output device 33 and the output plug 341 of the third power output device 34. The AC voltage is transmitted from the external power source to the power adapter 30 through the second plug 313, the cable 312 and the first plug 311 of the power input device 31, and then converted by the power converting circuitry of the printed circuit board inside the main body 30 into different regulated DC output voltages.

Please refer to FIG. 2 again. In a case that the first power output device 32 is selected for transmitting a first DC output voltage of 12V to the first electronic appliance 4, the AC voltage is converted by the power converting circuitry of the printed circuit board inside the main body 30 into the first DC output voltage. In another case that the second power output device 33 is selected for transmitting a second DC output voltage of 5V to the second electronic appliance 5, the AC voltage is converted into the second DC output voltage. In another case that the third power output device 34 is selected for transmitting a third DC output voltage of 3.3V to the third electronic appliance 6, the AC voltage is converted into the third DC output voltage.

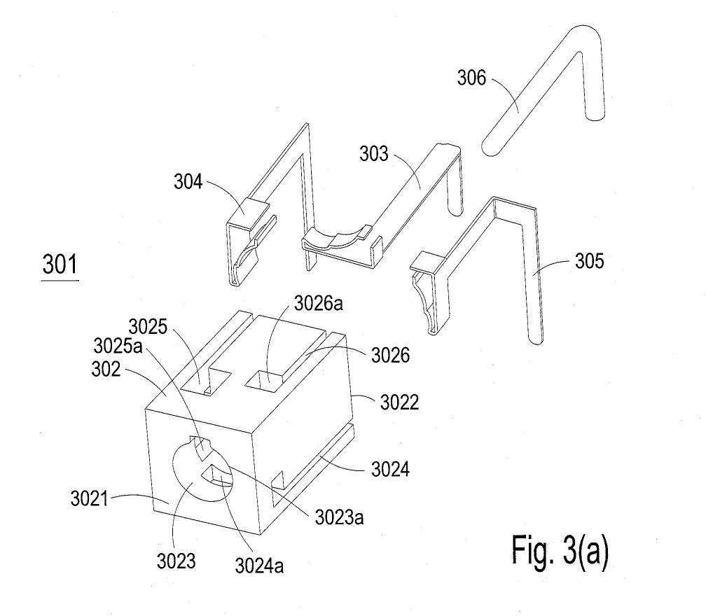

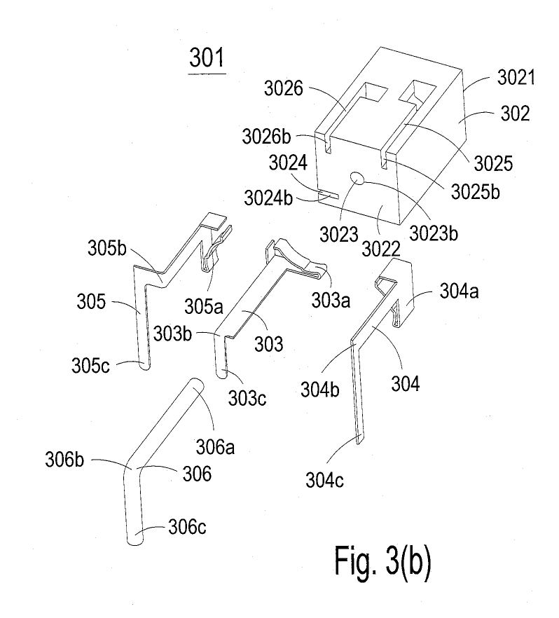

Referring to FIGS. 3(a) and 3(b), schematic front and rear exploded views of the electronic connector 301 shown in FIG. 2 are respectively illustrated. As shown in FIGS. 3(a) and 3(b), the electronic connector 301 includes a housing 302, a plurality of electricity-conducting elements 303, 304, 305 and a ground terminal 306. The housing 302 includes a first surface 3021, a second surface 3022 and a channel 3023. The first surface 3021 and the second surface 3022 are opposed to each other. The channel 3023 penetrates through the housing 302 from the first surface 3021 to the second surface 3022, such that a first opening 3023a and a second opening 3023b are formed in the first surface 3021 and the second surface 3022, respectively. The area of the second opening 3023b is smaller than that of the first opening 3023a. The housing 302 further includes a first receptacle 3024, a second receptacle 3025 and a third receptacle 3026.

The first receptacle 3024 includes a first end part 3024a and a second end part 3024b. The second receptacle 3025 includes a first end part 3025a and a second end part 3025b. The third receptacle 3026 includes a first end part 3026a and a second end part 3026b. The first end parts 3024a, 3025a and 3026a of the receptacles 3024, 3025 and 3026 are communicated with the channel 3023. In some embodiments, the receptacles 3024, 3025 and 3026 are extended from the second surface 3022 toward the first surface 3021. The first end parts 3024a, 3025a and 3026a of the receptacles 3024, 3025 and 3026 are located at different positions of the inner wall of the housing 302 and arranged in different distances with respect to the first surface 3021. The second end parts 3024b, 3025b and 3026c of the receptacles 3024, 3025 and 3026 are located at different positions of the second surface 3022.

The first electricity-conducting element 303, the second electricity-conducting element 304, the third electricity-conducting element 305 and the ground terminal 306 include respective first conducting parts 303a, 304a, 305a, 306a, respective bent parts 303b, 304b, 305b, 306b, and respective second conducting parts 303c, 304c, 305c, 306c. The bent parts 303b, 304b, 305b, 306b are arranged between the first conducting parts 303a, 304a, 305a, 306a and the second conducting parts 303c, 304c, 305c, 306c, respectively.

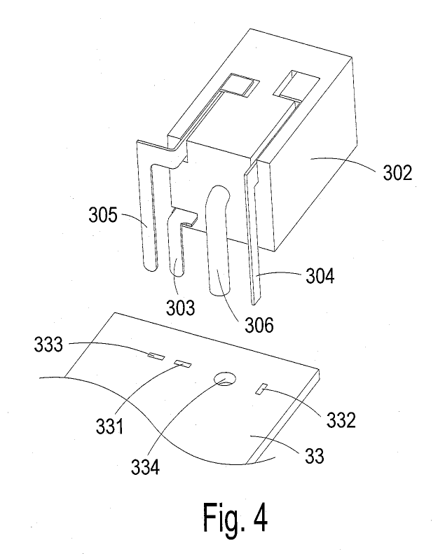

Referring to FIG. 4, a schematic assembled view of the electronic connector to be mounted on a circuit board is illustrated. As shown in FIGS. 3(a), 3(b) and 4, the first conducting part 303a of the first electricity-conducting element 303 is received within the first receptacle 3024, and the first conducting part 303a is partially exposed to the channel 3023. The bent part 303b and the second conducting part 303c of the first electricity-conducting element 303 are extended from the second surface 3022 of the housing 302 through the second end part 3024b of the first receptacle 3024. Similarly, the first conducting part 304a of the second electricity-conducting element 304 is received within the second receptacle 3025, and the first conducting part 304a is partially exposed to the channel 3023. The bent part 304b and the second conducting part 304c of the second electricity-conducting element 304 are extended from the second surface 3022 of the housing 302 through the second end part 3025b of the second receptacle 3025. Similarly, the first conducting part 305a of the third electricity-conducting element 305 is received within the third receptacle 3026, and the first conducting part 305a is partially exposed to the channel 3023. The bent part 305b and the second conducting part 305c of the third electricity-conducting element 305 are extended from the second surface 3022 of the housing 302 through the second end part 3026b of the third receptacle 3026. The first conducting part 306a of the ground terminal 306 penetrates through the second opening 3023b to the channel 3023. The bent part 306b and the second conducting part 306c of the ground terminal 306 are extended from the second surface 3022 of the housing 302 through the second opening 3023b.

After the electricity-conducting elements 303, 304, 305 and the ground terminal 306 are embedded into the housing 302, the second conducting parts 303c, 304c, 305c and 306c thereof are extended downwardly to be mounted onto the contact elements 331, 332, 333 and 334 of the circuit board 33, respectively. As a consequence, the AC voltage may be converted by the power converting circuitry of the circuit board 33 into different regulated DC output voltages, e.g. 12V, 5V and/or 3.3V, for powering different electronic apparatuses.

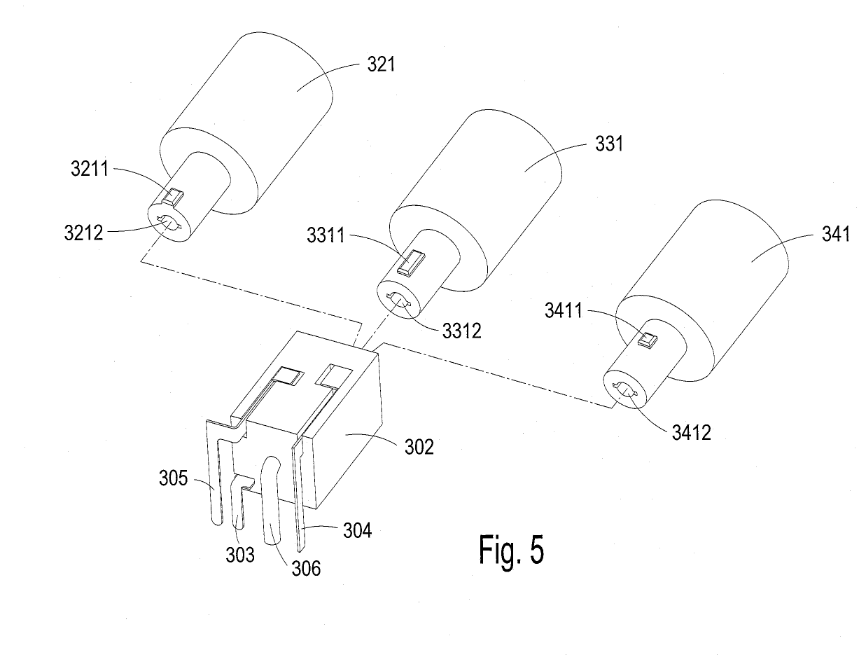

Please refer to FIG. 5, which is a partial perspective view illustrating the connection between the first output plugs 321, 331, 341 of the power output devices 32, 33, 34 and the electronic connector 301. The first output plugs 321, 331, 341 of the power output devices 32, 33, 34 have respective first conducting portions 3211, 3311, 3411 and respective second conducting portions 3212, 3312, 3412. In some embodiments, the first conducting portions 3211, 3311, 3411 are respectively disposed on the outer peripheries of the first output plugs 321, 331, 341, and the second conducting portions 3212, 3312, 3412 are respectively inserted into the channel 3023 of the electronic connector 301. In accordance with a specific feature of the present invention, the first conducting portions 3211, 3311, 3411 are differentially distant from the tip sides of the first output plugs 321, 331, 341. In a case that the first output plug 321 of the first power output device 32 is plugged into the channel 3023 of the electronic connector 301, the first conducting portion 3211 is electrically connected to the first conducting part 303a of the first electricity-conducting element 303, and the second conducting portion 3212 is electrically connected to the first conducting part 306a of the ground terminal 306. In another case the first output plug 331 of the second power output device 33 is plugged into the channel 3023 of the electronic connector 301, the first conducting portion 3311 is electrically connected to the first conducting part 304a of the second electricity-conducting element 304, and the second conducting portion 3312 is electrically connected to the first conducting part 306a of the ground terminal 306. In another case the first output plug 341 of the third power output device 34 is plugged into the channel 3023 of the electronic connector 301, the first conducting portion 3411 is electrically connected to the first conducting part 305a of the third electricity-conducting element 305, and the second conducting portion 3412 is electrically connected to the first conducting part 306a of the ground terminal 306. Due to the specific configuration of the electronic connectors 301, different regulated DC output voltages are selectively transmitted to the electronic appliances 4, 5 or 6 when a corresponding first output plug 321, 331 or 341 is plugged into the channel 3023 of the electronic connector 301.

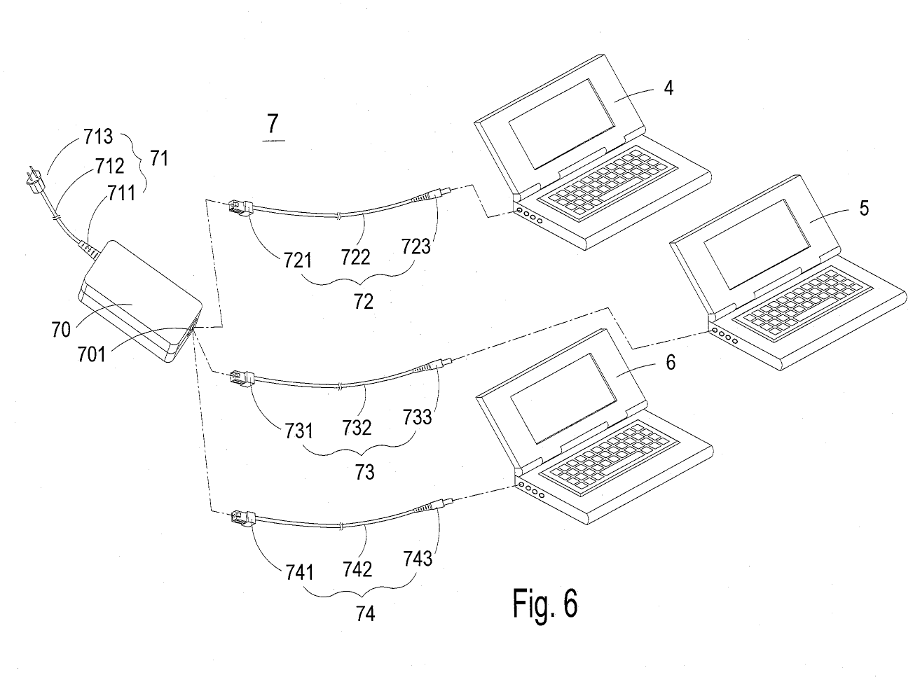

A further embodiment of a power adapter is illustrated is illustrated in FIG. 6. The AC voltage transmitted from the external power source is converted by the circuitry of a printed circuit board inside the power adapter 7 into different regulated DC output voltages, e.g. 12V, 5V and 3.3V, for powering different electronic apparatuses 4, 5 and 6, respectively. The power adapter 7 includes a main body 70, at least one power input device 71 and multiple power output devices 72, 73 and 74. The main body 70 includes a power input terminal, a power output terminal (i.e. an electronic connector 701) and a printed circuit board (not shown). The printed circuit board has a power converting circuit mounted thereon for converting the AC voltage into different regulated DC output voltages. The operation principles of the power converting circuit are known in the art, and are not redundantly described herein. Moreover, the power input device 71 includes a first input plug 711, a cable 712 and a second input plug 713. The power output devices 72, 73 and 74 have respective first output plugs 721, 731, 741, respective cables 722, 732, 742 and respective second output plugs 723, 733, 743.

The second plug 713 of the power input device 71 is plugged into an AC wall outlet for receiving an AC voltage. The first input plug 711 of the power input device 71 is connected to the input terminal of the main body 70. The output terminal (i.e. the electronic connector 701) of the main body 70 is selectively and detachably connected to the output plug 721 of the first power output device 72, the output plug 731 of the second power output device 73 and the output plug 741 of the third power output device 74. The AC voltage is transmitted from the external power source to the power adapter 70 through the second plug 713, the cable 712 and the first plug 711 of the power input device 71, and then converted by the power converting circuitry of the printed circuit board inside the main body 70 into different regulated DC output voltages.

Please refer to FIG. 6 again. In a case that the first power output device 72 is selected for transmitting a first DC output voltage of 12V to the first electronic appliance 4, the AC voltage is converted by the power converting circuitry of the printed circuit board inside the main body 70 into the first DC output voltage. In another case that the second power output device 73 is selected for transmitting a second DC output voltage of 5V to the second electronic appliance 5, the AC voltage is converted into the second DC output voltage. In another case that the third power output device 74 is selected for transmitting a third DC output voltage of 3.3V to the third electronic appliance 6, the AC voltage is converted into the third DC output voltage.

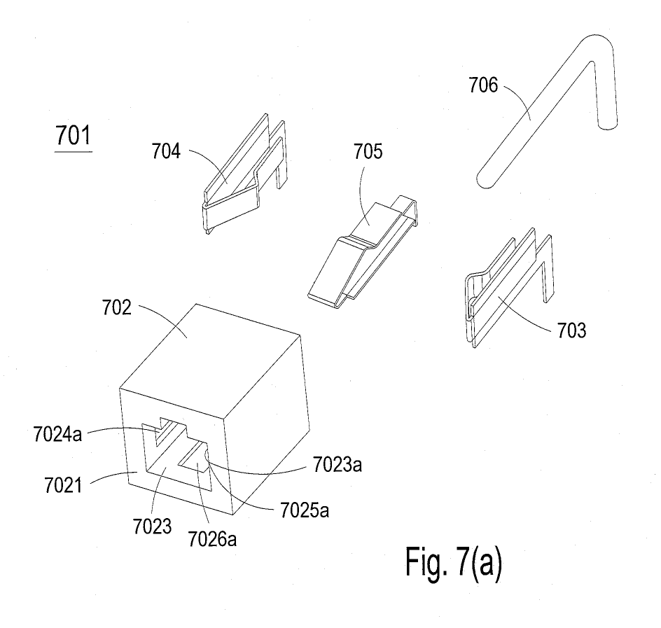

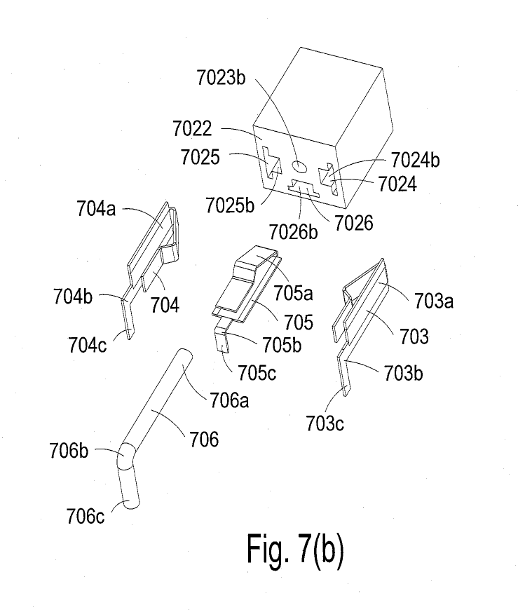

Referring to FIGS. 7(a) and 7(b), schematic front and rear exploded views of the electronic connector 701 shown in FIG. 6 are respectively illustrated. As shown in FIGS. 7(a) and 7(b), the electronic connector 701 includes a housing 702 and a plurality of electricity-conducting elements 703, 704, 705 and a ground terminal 706. The housing 702 includes a first surface 7021, a second surface 7022 and a channel 7023. The first surface 7021 and the second surface 7022 are opposed to each other. The channel 7023 penetrates through the housing 702 from the first surface 7021 to the second surface 7022, such that a first opening 7023a and a second opening 7023b are formed in the first surface 7021 and the second surface 7022, respectively. The area of the second opening 7023b is smaller than that of the first opening 7023a. The housing 702 further includes a first receptacle 7024, a second receptacle 7025 and a third receptacle 7026.

The first receptacle 7024 includes a first end part 7024a and a second end part 7024b. The second receptacle 7025 includes a first end part 7025a and a second end part 7025b. The third receptacle 7026 includes a first end part 7026a and a second end part 7026b. The first end parts 7024a, 7025a and 7026a of the receptacles 7024, 7025 and 7026 are communicated with the channel 7023. In some embodiments, the receptacles 7024, 7025 and 7026 are extended from the second surface 7022 toward the first surface 7021. The first end parts 7024a, 7025a and 7026a of the receptacles 7024, 7025 and 7026 are located at different sides of the inner wall of the housing 702 and arranged in different or identical distances with respect to the first surface 7021. The second end parts 7024b, 7025b and 7026b of the receptacles 7024, 7025 and 7026 are located at different positions of the second surface 7022.

The first electricity-conducting element 703, the second electricity-conducting element 704, the third electricity-conducting element 705 and the ground terminal 706 include respective first conducting parts 703a, 704a, 705a, 706a, respective bent parts 703b, 704b, 705b, 706b, and respective second conducting parts 703c, 704c, 705c, 706c. The bent parts 703b, 704b, 705b, 706b are arranged between the first conducting parts 703a, 704a, 705a, 706a and the second conducting parts 703c, 704c, 705c, 706c, respectively.

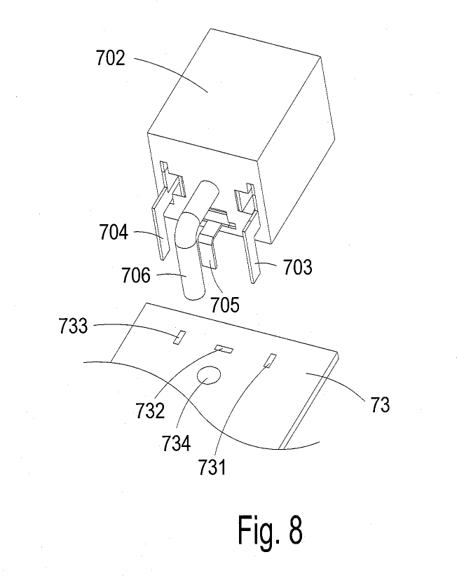

Referring to FIG. 8, a schematic assembled view of the electronic connector to be mounted on a circuit board is illustrated. As shown in FIGS. 7(a), 7(b) and 8, the first conducting part 703a of the first electricity-conducting element 703 is received within the first receptacle 7024, and the first conducting part 703a is partially exposed to the channel 7023. The bent part 703b and the second conducting part 703c of the first electricity-conducting element 703 are extended from the second surface 7022 of the housing 702 through the second end part 7024b of the first receptacle 7024. Similarly, the first conducting part 704a of the second electricity-conducting element 704 is received within the second receptacle 7025, and the first conducting part 704a is partially exposed to the channel 7023. The bent part 704b and the second conducting part 704c of the second electricity-conducting element 704 are extended from the second surface 7022 of the housing 702 through the second end part 7025b of the second receptacle 7025. Similarly, the first conducting part 705a of the third electricity-conducting element 705 is received within the third receptacle 7026, and the first conducting part 705a is partially exposed to the channel 7023. The bent part 705b and the second conducting part 705c of the third electricity-conducting element 705 are extended from the second surface 7022 of the housing 702 through the second end part 7026b of the third receptacle 7026. The first conducting part 706a of the ground terminal 706 penetrates through the second opening 7023b to the channel 7023. The bent part 706b and the second conducting part 706c of the ground terminal 706 are extended from the second surface 7022 of the housing 702 through the second opening 7023b.

After the electricity-conducting elements 703, 704, 705 and the ground terminal 706 are embedded into the housing 702, the second conducting parts 703c, 704c, 705c and 706c thereof are extended downwardly to be mounted onto the contact elements 731, 732, 733 and 734 of the circuit board 73, respectively. As a consequence, the AC voltage may be converted by the power converting circuitry of the circuit board 73 into different regulated DC output voltages, e.g. 12V, 5V and/or 3.3V, for powering different electronic apparatuses.

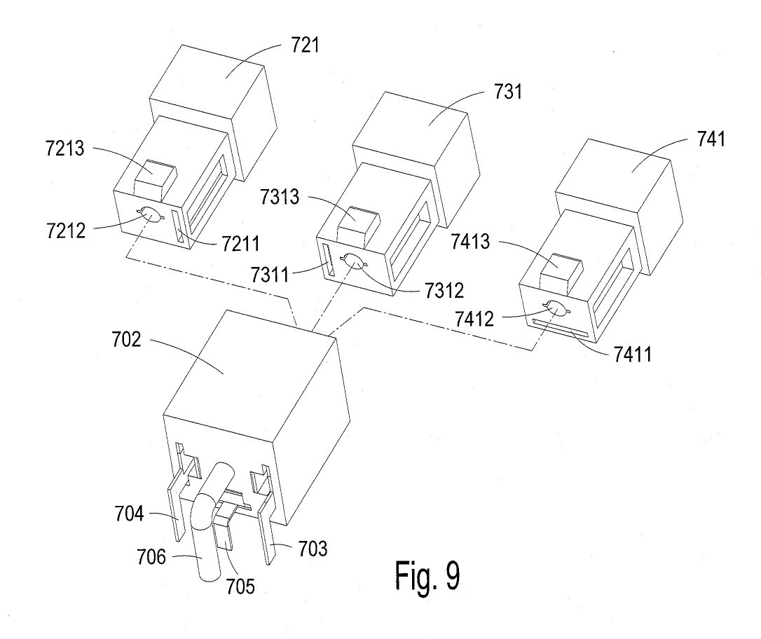

Please refer to FIG. 9, which is a partial perspective view illustrating the connection between the first output plugs 721, 731, 741 of the power output devices 72, 73, 74 and the electronic connector 701. The first output plugs 721, 731, 741 of the power output devices 72, 73, 74 have respective first conducting portions 7211, 7311, 7411, respective second conducting portions 7212, 7312, 7412, and respective fixing elements 7213, 7313, 7413. In some embodiments, the first conducting portions 7211, 7311 and 7411 are disposed on the tip sides of the first output plugs 721, 731 and 741, respectively. The second conducting portions 7212, 7312 and 7412 are inserted into the channel 7023 of the electronic connector 701. In accordance with a specific feature of the present invention, the first conducting portions 7211, 7311, 7411 are disposed on different positions (for example at the right edge, the left edge and the bottom edge) of the tip sides of the first output plugs 721, 731, 741. In a case that the first output plug 721 of the first power output device 72 is plugged into the channel 7023 of the electronic connector 701, the first conducting portion 7211 is electrically connected to the first conducting part 703a of the first electricity-conducting element 703, and the second conducting portion 7212 is electrically connected to the first conducting part 706a of the ground terminal 706. In another case the first output plug 731 of the second power output device 73 is plugged into the channel 7023 of the electronic connector 701, the first conducting portion 7311 is electrically connected to the first conducting part 704a of the second electricity-conducting element 704, and the second conducting portion 7312 is electrically connected to the first conducting part 706a of the ground terminal 706. In another case the first output plug 741 of the third power output device 74 is plugged into the channel 7023 of the electronic connector 701, the first conducting portion 7411 is electrically connected to the first conducting part 705a of the third electricity-conducting element 705, and the second conducting portion 7412 is electrically connected to the first conducting part 706a of the ground terminal 706. Due to the specific configuration of the electronic connectors 701, different regulated DC output voltages are selectively transmitted to the electronic appliances 4, 5 or 6 when a corresponding first output plug 721, 731 or 741 is plugged into the channel 7023 of the electronic connector 701. In some embodiments, the fixing elements 7213, 7313, 7413 of the first output plug 721, 731, 741 have complementary shapes mating with the fixing recesses (not shown) of the electronic connector 701. Alternatively, the first output plug 721, 731, 741 have respective indentations to receive the electricity-conducting elements 703, 704, 705 therein, thereby enhancing secure attachment between the first output plug 721, 731, 741 and the electronic connector 701.

From the above description, the electronic connector and the power adapter are capable of selectively transmitting different regulated DC output voltages to different electronic appliances due to the specific configuration of the electronic connector. Therefore, by using a single power adapter of the present invention, different regulated DC output voltages can be transmitted to different electronic appliances so as to reduce the fabricating cost.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic connector having multiple outputs, said electronic connector comprising:
a housing having a channel therein; and
a plurality of electricity-conducting elements separated from each other, each electricity-conducting element including a first conducting part and a second conducting part, said first conducting part being partially received within said housing and partially exposed to said channel, said second conducting part being extended from said housing, wherein one of said electricity-conducting elements is selected to transmit an output voltage through said first conducting part and said second conducting part of said selected electricity-conducting element.

2. The electronic connector according to claim 1 wherein said housing further includes a first surface and a second surface opposed to each other, and said channel penetrates through said housing from said first surface to said second surface, such that a first opening and a second opening are formed in said first surface and said second surface, respectively.

3. The electronic connector according to claim 2 wherein the area of sad second opening is smaller than that of said first opening, and said housing further includes a plurality of receptacles for receiving said first conducting parts of said electricity-conducting elements.

4. The electronic connector according to claim 3 wherein said plurality of receptacles include three receptacles extended from said second surface toward said first surface, said first ends of said receptacles are communicated with said channel, and said second ends of said receptacles are located at different positions of said second surface.

5. The electronic connector according to claim 4 wherein said first ends of said receptacles are located at different positions of the inner wall of said housing.

6. The electronic connector according to claim 5 wherein said first ends of said receptacles are arranged in different distances with respect to said first surface.

7. The electronic connector according to claim 5 wherein said first ends of said receptacles are located at different sides of the inner wall of said housing.

8. The electronic connector according to claim 1 wherein the number of said electricity-conducting elements is three, and said electronic connector further includes a ground terminal.

9. The electronic connector according to claim 8 wherein each of said electricity-conducting elements and said ground terminal includes a first conducting part, a bent part and a second conducting part, wherein said bent part is arranged between said first conducting part and said second conducting part.

10. The electronic connector according to claim 9 wherein said bent parts and said second conducting parts are extended from said housing, and said second conducting parts of said electricity-conducting elements and said ground terminal are extended along a same direction.

11. A power adapter comprising:
a power input device;
a main body including a circuit board and an electronic connector, said circuit board being electrically interconnected between said power input device and said electronic connector, said electronic connector including a plurality of electricity-conducting elements, each electricity-conducting element including a first conducting part and a second conducting part, wherein said first conducting parts of said electricity-conducting elements are arranged at different positions of said electronic connector; and
a plurality of power output devices including respective first output plugs, which have respective first conducting portions corresponding to respective first conducting parts of said electricity-conducting elements, wherein said first output plugs of said power output devices are selectively plugged into said electronic connector to output different regulated output voltages.

12. The power adapter according to claim 11 wherein said electronic connector further includes a housing, said housing includes a first surface, a second surface and a channel, said first surface and said second surface are opposed to each other, and said channel penetrates through said housing from said first surface to said second surface, such that a first opening and a second opening are formed in said first surface and said second surface, respectively.

13. The power adapter according to claim 12 wherein said electricity-conducting elements of said electronic connector are separated from each other, said first conducting part of each electricity-conducting element is partially received within said housing and partially exposed to said channel, and said second conducting part of each electricity-conducting element is extended from said housing.

14. The power adapter according to claim 13 wherein said housing further includes three receptacles for receiving said first conducting parts of said electricity-conducting elements, said receptacles are extended from said second surface toward said first surface, said first ends of said receptacles are communicated with said channel, and said second ends of said receptacles are located at different positions of said second surface.

15. The power adapter according to claim 14 wherein said first ends of said receptacles are located at different positions of the inner wall of said housing.

16. The power adapter according to claim 14 wherein said first ends of said receptacles are arranged in different distances with respect to said first surface.

17. The power adapter according to claim 14 wherein said first ends of said receptacles are located at different sides of the inner wall of said housing.

18. The power adapter according to claim 11 wherein the number of said electricity-conducting elements is three, and said electronic connector further includes a ground terminal.

19. The power adapter according to claim 18 wherein each of said electricity-conducting elements and said ground terminal includes a first conducting part, a bent part and a second conducting part, wherein said bent part is arranged between said first conducting part and said second conducting part.

20. The power adapter according to claim 18 wherein said first output plugs of said power output devices include respective first conducting portions and second conducting portions to be electrically connected to corresponding electricity-conducting elements and said ground terminal, respectively.
